(19) United States
(12) Patent Application Publication
(10) Pub. No.: US 2020/0103800 A1
(43) Pub. Date: Apr. 2, 2020

(54) IMAGE HEATING APPARATUS

(71) Applicant: CANON KABUSHIKI KAISHA, Tokyo (JP)

(72) Inventors: Yuki Nishizawa, Yokohama-shi (JP); Minoru Hayasaki, Mishima-shi (JP); Aoji Isono, Naka-gun (JP); Akira Kuroda, Numazu-shi (JP); Takaaki Tsuruya, Mishima-shi (JP)

(21) Appl. No.: 16/586,343

(22) Filed: Sep. 27, 2019

(30) Foreign Application Priority Data
Sep. 28, 2018 (JP) 2018-183212

(51) Int. Cl. G03G 15/20; H05B 6/36

(52) U.S. Cl. CPC G03G 15/2053; G03G 15/2017; H05B 6/365

(57) ABSTRACT

An image heating apparatus includes a sleeve including divided heat generating layers, an exciting coil provided in an inside space of the sleeve, a magnetic core provided inside the exciting coil, and a temperature detecting element opposing one of the divided heat generating layers. An induced current is generated in the divided heat generating layers by passing an alternating current through the exciting coil, and the divided heat generating layers generate heat. An image on the recording material is heated by the divided heat generating layers. The image heating apparatus further comprises a current monitoring sensor configured to monitor a current flowing through the above-described one of the divided heating generating layers.

### FIELD OF THE INVENTION AND RELATED ART

The present invention relates to an image heating apparatus such as a fixing device mounted in an image forming apparatus of an electrophotographic type, and particularly relates to the image heating apparatus of an electromagnetic induction heating type.

As the fixing device of the electromagnetic induction heating type, there is a fixing device in which an exciting coil and a magnetic core are provided inside a fixing sleeve and in which the fixing sleeve is caused to generate heat by an induced current flowing in a circumferential direction of the fixing sleeve (Japanese Laid-Open Patent Application (JP-A) 2014-026267).

Here, the case where some breakage generates in a heat generating layer (electroconductive layer exists (part (a) of FIG. 23), and at this time, a current flowing through the electroconductive layer detours around an end portion C2 of a crack C. As a result, large heat generation occurs locally. On the other hand, in JP-A 2015-118232, a heat generating layer is electrically divided with respect to a rotational axis direction. This heat generating layer of a fixing sleeve is JP-A 2015-118232 includes a plurality of divided heat generating layers. As a result, an amount of a current detouring at a crack end portion is suppressed, so that locally large heat generation is prevented from occurring (part (b) of FIG. 23).

Incidentally, even when the crack C does not occur, for example, it would be also considered that control of the exciting coil is in an abnormal status due to inconvenience of a controller and thus the fixing sleeve abnormally generates heat. It would be considered that an element for monitoring a temperature of the fixing sleeve is provided for preparing such a situation and that during abnormal detection, a safety circuit for shutting off supply of electric power to the exciting coil.

However, in a fixing device using the fixing sleeve including the divided heat generating layers as shown in part (b) of FIG. 23, when the crack occurs in the divided heat generating layer corresponding to a position where a temperature detecting element is provided, this divided heat generating layer does not generate heat. On the other hand, due to the inconvenience of the controller, when an alternating current continuously flows through the exciting coil, there is a possibility that the divided heat generating layers in which the crack does not occur continue heat generation and increases in temperature to an abnormal temperature. At this time, the temperature detecting element corresponding to the divided heat generating layer in which the crack occurs cannot detect the abnormal temperature, so that the safety circuit does not function. If all the divided heat generating layers are provided with temperature detecting elements, the safety circuit functions even when the crack occurs at any place, but results in increased cost.

A principal object of the present invention is to provide an image heating apparatus capable of shutting off energization to an exciting coil even when a crack occurs at any of a plurality of ring-shaped divided heat generating layers.

### SUMMARY OF THE INVENTION

According to an aspect of the present invention, there is provided an image heating apparatus comprising: a sleeve which is rotatable while contacting a recording material on which an image is formed, the sleeve including a plurality of divided heat generating layers arranged along a longitudinal direction of the sleeve, wherein each of the divided heat generating layers has a ring shape; an exciting coil provided in an inside space of the sleeve, wherein the exciting coil has a helix substantially parallel to the longitudinal direction of the sleeve; a magnetic core provided inside the exciting coil; and a temperature detecting element opposing one of the divided heat generating layers, wherein an induced current is generated in the divided heat generating layers by passing an alternating current through the exciting coil, and the divided heat generating layers generate heat, wherein the image on the recording material is heated by the divided heat generating layers, and wherein the image heating apparatus further comprises a current monitoring sensor configured to monitor a current flowing through the one of the divided heat generating layers.

Further features of the present invention will become apparent from the following description of exemplary embodiments with reference to the attached drawings.

### BRIEF DESCRIPTION OF THE DRAWINGS

FIG. 1 is a cross-sectional view showing a general structure of an image forming apparatus in which an image heating apparatus according to an embodiment of the present invention is mounted.

FIG. 2 is a cross-sectional view of a principal part of the image heating apparatus according to the embodiment.

FIG. 3 is a front view of the principal part of the image heating apparatus according to the embodiment as seen in an arrow E direction in FIG. 2.

Parts (a) and (b) of FIG. 4 are illustrations of heat generating patterns.

FIG. 5 is a schematic diagram of a magnetic field at a periphery of a core and an induced current induced to a sleeve heat generating pattern.

FIG. 6 is a schematic diagram for illustrating temperature control by a thermistor.

FIG. 7 is a schematic diagram for illustrating the case where breakage C such as a crack occurs in a rotatable member.

FIG. 8 is a schematic diagram for illustrating the case where the breakage C occurs at a place other than a position where a temperature detecting element is provided.

FIG. 9 is an illustration of a measurement principle of a current sensor of a current transformer type.

FIG. 10 is a sectional view showing a structure of a current monitoring sensor in a first embodiment.

FIG. 11 is a perspective view representing that magnetic flux generates by a circumferential current.

FIG. 12 is a perspective view in the case where a magnetic core is provided in parallel to a circumferential direction of a fixing sleeve.

FIG. 13 is a sectional view showing a position of the current monitoring sensor as seen in a longitudinal direction of the rotatable member.

Parts (a) and (b) of FIG. 14 are diagrams showing voltage waveforms in the first embodiment.

FIG. 15 is a diagram showing a structure of a current monitoring sensor in a second embodiment.

FIG. 16 is a diagram showing a voltage waveform in the second embodiment.

FIG. 17 is a diagram showing a structure of a current monitoring sensor in the second embodiment.

Parts (a) and (b) of FIG. 18 are diagrams showing a structure of a current monitoring sensor in a third embodiment.

FIG. 19 is a diagram showing a voltage waveform in the third embodiment.

FIG. 20 is a diagram showing a structure of a current monitoring sensor in a fourth embodiment.

Parts (a) and (b) of FIG. 21 are diagrams showing voltage waveforms in the fourth embodiment.

FIG. 22 is a diagram showing another structure of the current monitoring sensor in the fourth embodiment.

Parts (a) and (b) of FIG. 23 are schematic views showing currents when cracks occur in heat generating patterns in the case where a heat generating layer is not divided with respect to a longitudinal direction and in the case where the heat generating layer is divided with respect to the longitudinal direction, respectively.

### DESCRIPTION OF EMBODIMENTS

In the following, embodiments of the present invention will be described with reference to the drawings.

### First Embodiment

### Image Forming Apparatus

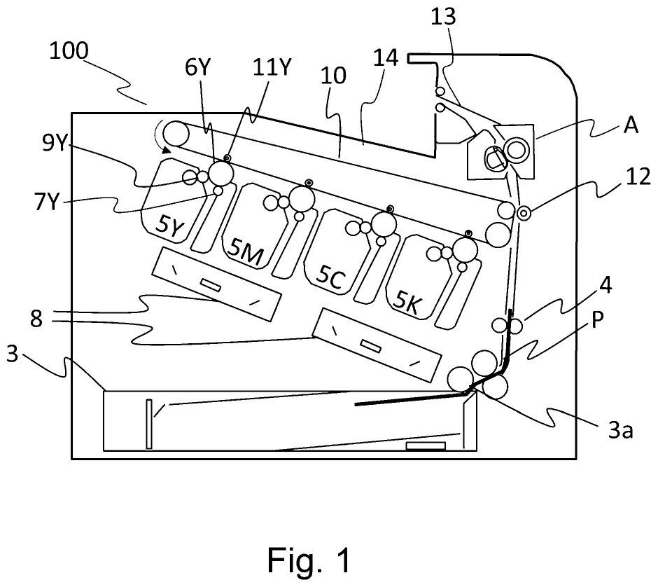

First, a full-color laser beam printer 100 which is an image forming apparatus in which an image heating apparatus according to an embodiment of the present invention is mounted will be described on the basis of FIG. 1. At a lower portion of the printer 100, a cassette 3 is accommodated so as to be capable of being pulled out. In the cassette 3, sheets P as a recording material are stacked and accommodated. The sheets P are separated one by one by a separation roller 3a, and the separated sheet P is fed to a registration roller pair 4.

The printer 100 includes image forming stations (image forming portions) 5Y, 5M, 5C and 5K which correspond to colors of yellow, magenta, cyan and black, respectively, and which are arranged obliquely in a line. The image forming portion 5Y includes a photosensitive drum 6Y which is an image bearing member, and a charging means 7Y for electrically charging a surface of the photosensitive drum 6Y uniformly. Further, below the image forming portion 5Y, a scanner unit 8 for forming an electrostatic latent image on the photosensitive drum 6Y by irradiating the photosensitive drum surface with a laser beam on the basis of image information is provided. The scanner unit 8 forms the electrostatic latent image on the photosensitive drum 6Y, and the electrostatic latent image is developed into a toner image by depositing toner thereon by a developing means 9Y.

The toner image is transferred onto an intermediary transfer belt 10 at a primary transfer portion 11Y. The intermediary transfer belt 10 is rotationally driven in an arrow direction, and a similar step is performed in each of the image forming portions 5M, 5C and 5K, so that the toner images are superposed on each other. The superposed toner images are transferred onto the sheet P at a secondary transfer portion 12 and pass through an image heating apparatus A, so that a fixed image is formed on the sheet P. The sheet P passes through a discharge feeding portion 13 and is discharged and stacked on a stacking portion 14.

### Image Heating Apparatus

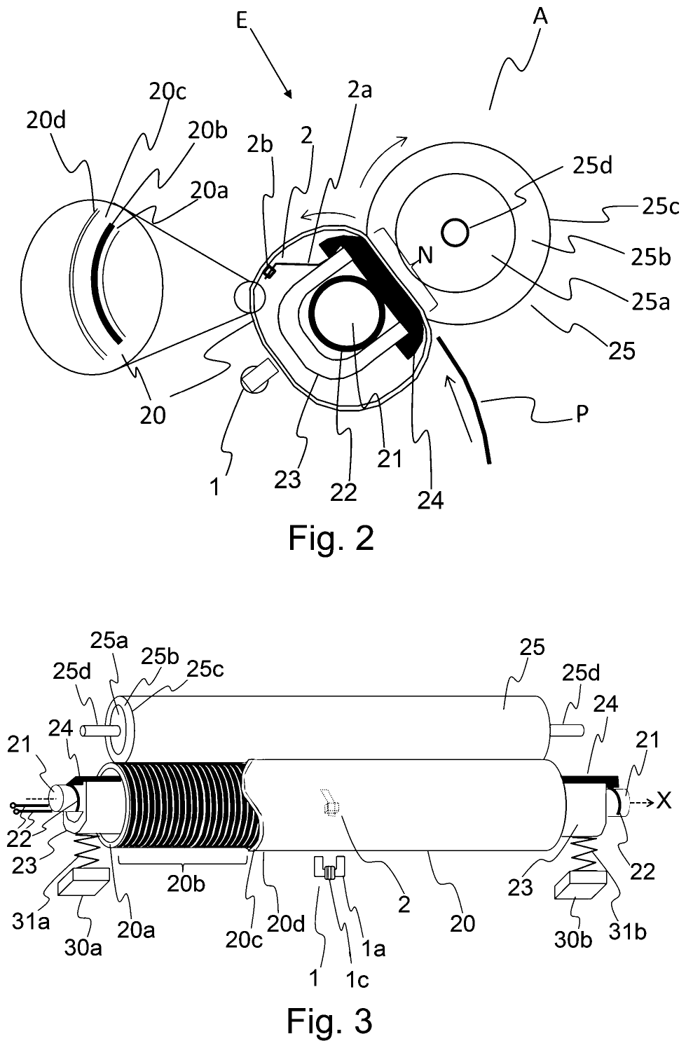

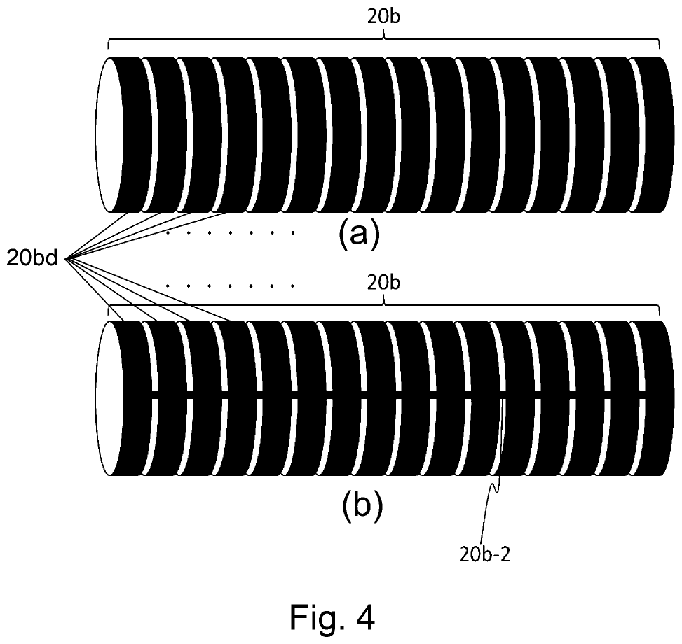

The image heating apparatus A according to this embodiment of the present invention is a fixing device of an electromagnetic induction heating type. FIG. 2 is a cross-sectional side view of a principal part of the image heating apparatus A of this embodiment, and FIG. 3 is a front view of the principal part of the image heating apparatus A as seen in an arrow E direction in FIG. 2. Incidentally, in FIG. 3, a fixing sleeve 20 is represented by developing an inside structure at a part thereof with respect to a longitudinal direction in order to illustrate a layer structure. Here, as regards members constituting the image heating apparatus A, the longitudinal direction refers to a direction perpendicular to a recording material feeding direction and a recording material thickness direction.

In this embodiment, in the fixing sleeve 20, as shown in part (a) of FIG. 4, a heat generating pattern 20b consisting of a plurality of ring-shaped divided heat generating layers 20bd which are electrically divided portions with respect to the longitudinal direction of the fixing sleeve 20 is formed. By such a shape of the heat generating pattern 20b, a flowing direction of an induced current is limited to a circumferential direction (circulating direction), so that when a crack occurs in the heat generating pattern 20b, it is possible to suppress an amount of a current flowing while detouring around the crack. As a result, it is possible to avoid a problem such that the current concentrates and results in a locally large heat generation amount.

Incidentally, the plurality of divided heat generating layers 20bd in the heat generating pattern 20b are not necessarily needed to be electrically divided with each other as shown in part (a) of FIG. 4, but may also be partially connected by a connecting portion 20b-2 as shown in part (b) of FIG. 4. Thus, the divided heat generating layers 20bd of the heat generating pattern 20b may only be required to have a shape such that at least a part thereof is divided with each other with respect to the circumferential direction of the fixing sleeve 20.

In this embodiment, as seen in the longitudinal direction of the fixing sleeve 20, a nip N is formed between the fixing sleeve 20 and a pressing roller 25 by a film guide 24 as a nip-forming member (FIG. 2). The toner image on the recording material is heated in the nip N, with the result that the toner image on the recording material is fixed as a fixed image on the recording material.

A magnetic core 21 is inserted into the fixing sleeve 20 in an axial direction (an arrow Y direction in FIG. 3), and an exciting coil 22 is formed by being wound around an outer periphery of the magnetic core 21 in a helical shape (a helical axis is substantially parallel to an X axis). By passing an alternating current through the exciting coil 22, the exciting coil 22 generates an alternating magnetic field, and the magnetic core 21 induces its magnetic lines of force (magnetic flux) to an inside of the fixing sleeve 20 and has the function of forming a path (magnetic path) of the magnetic lines of force.

In such an image heating apparatus A of this embodiment, a current monitoring sensor 1 as a conduction monitoring means of the heat generating layer of the fixing sleeve 20 and a thermistor 2 for sensing (detecting) abnormal temperature rise of the fixing sleeve 20 and for shutting off energization to the exciting coil 22 described later are further provided. The thermistor 2 functions as a first element used for detecting the abnormal temperature rise and for shutting off the energization to the exciting coil 22.

Further, although being specifically described later, the current monitoring sensor 1 monitors whether the divided heat generating layer 20bd is not broken and is electrically conducted or the divided heat generating layer 20bd is broken and is not electrically conducted. The current monitoring sensor 1 functions as a second element used for shutting off energization to the exciting coil.

In the following, respective members relating to this embodiment will be specifically described.

### Fixing Sleeve

The fixing sleeve 20 in this embodiment is flexible cylindrical member (cylindrical rotatable member) which is used as a fixing film and which is 30 mm in inner diameter and 235 mm in length with respect to the longitudinal direction. On an about 60 μm-thick polyimide base layer 20a, an about 5 μm-thick heat generating pattern 20b is provided as a heat generating layer. Further, on the heat generating pattern 20b, an about 200 μm-thick elastic layer 20c of a silicone rubber, a fluorine-containing rubber or the like, and an about 15 μm-thick parting layer 20d of a PFA resin tube as an outermost layer are provided.

As regards the heat generating pattern 20b, each f rings (divided heat generating layers 20bd) is about 3 mm in width with respect to the longitudinal direction of the fixing sleeve and is about 0.1 mm in interval between adjacent rings, and the heat generating pattern 20b is formed in an entire region of the fixing sleeve 20 with respect to the longitudinal direction. The heat generating pattern 20b is formed by means of printing, plating, sputtering, vapor deposition, or the like, and in this embodiment, the heat generating pattern 20b is formed by subjecting silver ink to screen printing. Further, although the heat generating pattern 20b is electrically divided with respect to the longitudinal direction of the fixing sleeve 20, the heat generating pattern 20b is formed in an electrically connected ring shape in a 360° regional direction with respect to a circumferential direction.

### Pressing Roller

A pressing roller 25 as an opposing member opposing the fixing sleeve 20 includes a core metal 25a and an elastic (material) layer 25b molded and coated in a roller shape concentrically around the core metal 25a, and a parting layer 25c is provided as a surface layer. The elastic layer 25b may preferably be formed of a material, having a good heat-resistant property, such as a silicone rubber, a fluorine-containing rubber or a fluorosilicone rubber.

Shafts 25d of the core metal 25a at opposite end portions with respect to the longitudinal direction are provided by being freely held (supported) by chassis (not shown) of the fixing device through bearings. A pressing stay 23 has a function of reinforcing a film guide 24 made of a resin material. The pressing stay 23 is made of a resin material. The film guide 24 contacting the pressing stay 23 forms a fixing nip N in cooperation with the pressing roller 25 between the fixing sleeve 20 and the pressing roller 25. In FIG. 2, when the pressing roller 25 is regionally driven in the clockwise direction in the figure by an unshown driving means, the fixing sleeve 20 is rotated in an arrow direction (counterclockwise direction) by a frictional force with an outer surface of the fixing sleeve 20, and is capable of nipping and feeding the sheet P while heating sheet P in the nip N.

Incidentally, in the opposite end portions of the above-described pressing stay 23, by compressedly providing pressing springs 31a and 31b between the pressing stay 23 and a device chassis-side spring receiving member 30a and between the pressing stay 23 and a device chassis-side spring receiving member 30b, respectively, a pressing force (pressure) of about 100N-250N (about 10 kgf-about 25 kgf) in total pressure is applied to the pressing stay.

### Magnetic Field Generating Means

Into a hollow portion of the fixing sleeve 20, as a first magnetic core for inducing magnetic lines of force of an alternating means filed, a cylindrical magnetic core 21 of 15 mm in diameter and 250 mm in length is inserted. The monitor 21 is constituted by a material small in hysteresis loss and high in specific permeability, for example, by a high-permeability soft magnetic material (member) such as sintered ferrite or a ferrite resin material.

Around an outer periphery of the magnetic core 21, a copper wire material (single lead wire) which is coated with heat-resistant polyamideimide and which is 1-2 mm in diameter is wound in a coil shape and constitutes the exciting coil 22. In FIG. 2, the pressing stay 23 is made of non-magnetic stainless steel, and the film guide 24 is constituted by a heat-resistant resin material such as PPS and also functions as the nip-forming member as described above.

### Thermistor

In FIG. 2, the thermistor 2 as a temperature detecting member is provided by being fixed to the film guide 24 and includes a spring plate 2a as a supporting member which extends toward an inner surface of the fixing sleeve 20 and which has spring elasticity and includes a thermistor element 2b provided at a free end portion of this spring plate 2a. The thermistor element 2b is urged against the inner surface of the fixing sleeve 20 by spring electricity of the spring plate 2a and thus is held in a contact state, and measures an inner surface temperature of the fixing sleeve 20.

The thermistor 2 is provided inside the fixing sleeve 20 (indicated by a dotted line in FIG. 3) and monitors the inner surface temperature of the fixing sleeve 20 at a central portion with respect to an X-axis direction. Further, the current monitoring sensor 1 as a conduction monitoring means for monitoring electric conduction of the divided heat generating pattern 20b and the thermistor 2 for detecting the temperature of the fixing sleeve 20 are disposed at the same position with respect to the longitudinal direction (X-axis direction) of the fixing sleeve 20.

### Heating Principle of Fixing Sleeve

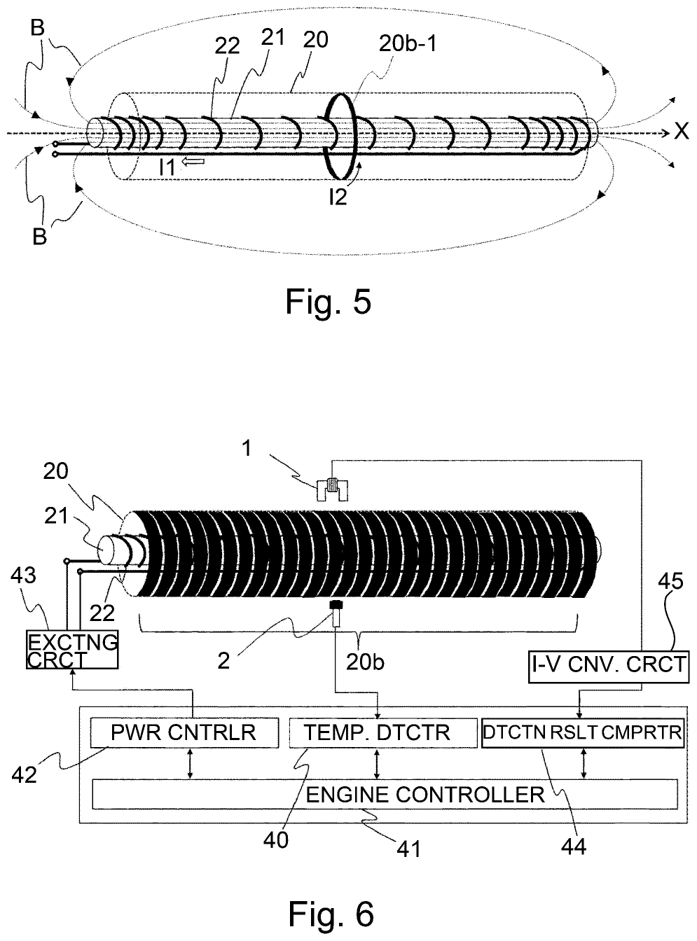

FIG. 5 is a schematic view of a magnetic field at a periphery of the magnetic core 21 and an induced current induced in the heat generating pattern 20b. The magnetic core 21 forms a path (magnetic path) of magnetic lines of force with respect to the X-axis direction of the fixing sleeve 20. The number of winding of the exciting coil 21 around the magnetic core 21 is about 15-25 (times). At the instant when a current increases in a direction of an arrow I1 on the exciting coil 22, the magnetic core 21 induces the magnetic lines of force indicated by dotted lines B in the figure. A change in this magnetic field induces a current into the heat generating pattern 20b of the fixing sleeve 20. The heat generating pattern 20b generates Joule heat by the induced current.

A divided heat generating layer 20b-1 is one of many divided heat generating layers 20bd arranged. A heat generation principle is in conformity with the Faraday's law. Induced electromotive force V causing the current to pass through a circuit of the divided heat generating layer 20b-1 is proportional to a change of time of magnetic flux perpendicularly penetrating the circuit. The induced electromotive force V is represented by the following formula (1). The induced electromotive force V is proportional to the product of a change Δφ/Δt of the magnetic flux perpendicularly penetrating the divided heat generating layer 20b-1 in a minute time Δt and the number of winding N.

$$V = - N \frac{ ΔΦ}{Δ t}$$

V: induced electromotive force
N: the NB of image of coil
Δφ/Δt: change of magnetic flux perpendicularly penetrating circuit in minute time Δt

By this induced electromotive force V, the current is caused to flow in the case where the divided heat generating layer 20b-1 is connected with respect to the circumferential direction (circulating direction) of the fixing sleeve 20, so that Joule heating is caused. On the other hand, in the case where the divided heat generating layer 20b-1 is not connected with respect to the circumferential direction, the current does not flow and thus the Joule heating does not occur.

### Heating Control

FIG. 6 is a schematic view for illustrating heating control by the thermistor 2. The ring-shaped heat generating pattern 20b is arranged over an entire region of the fixing sleeve 20 with respect to the longitudinal direction, so that entirety of the fixing sleeve 20 with respect to the longitudinal direction is heated. The thermistor 2 monitors the temperature of the fixing sleeve 20 at a central portion with respect to the longitudinal direction. Incidentally, in this embodiment, the thermistor 2 is provided inside the fixing sleeve 20, but in FIG. 6, the thermistor 2 is illustrated outside the fixing sleeve 20 in order to enhance viewability. The through 2 is connected to a temperature detecting portion 40, and sends temperature information to an engine controller 41 on the basis of a detected temperature.

The engine controller 41 calculates electric power to be supplied to the fixing sleeve 20 and supplies a high-frequency current from an exciting circuit 43 to the exciting coil 22 through an electric power controller 42. As a result, a surface temperature of the fixing sleeve 20 is maintained and adjusted at a predetermined target temperature (about 150-200° C.).

Further, in the case where the thermistor 2 detects a temperature of a predetermined value (for example 220° C.) or more, the engine controller 41 discriminates that high temperature abnormality occurs and prohibits electric power supplied to the fixing sleeve 20, and thus urgently stops the image forming operation.

### Measures During Breakage of Fixing Sleeve

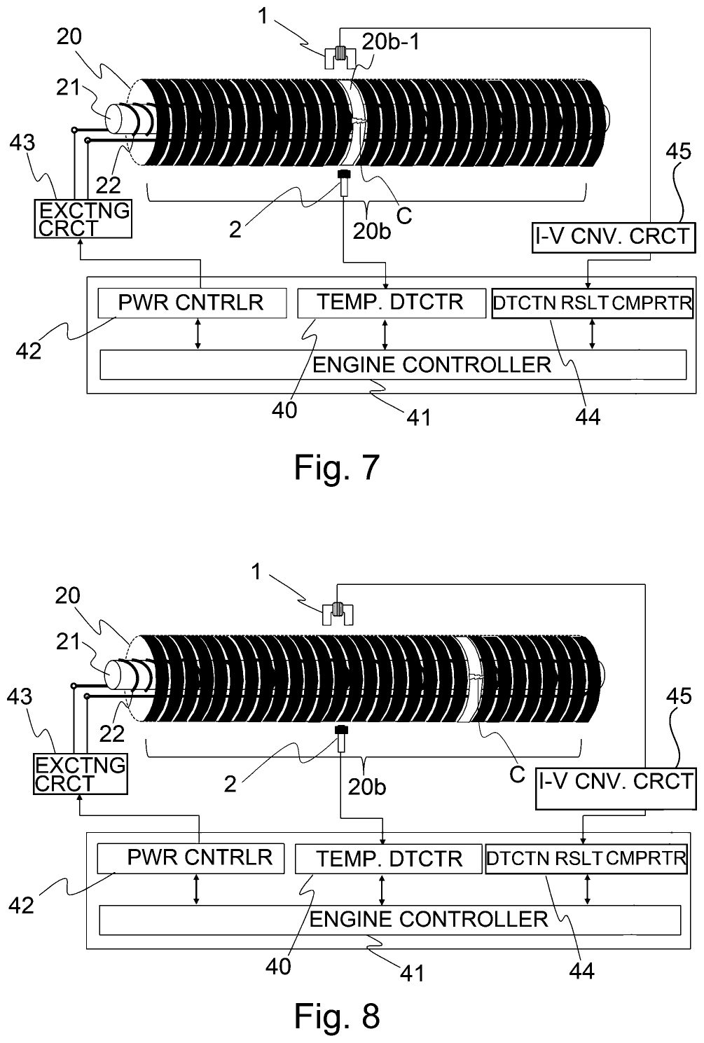

Here, as shown in FIG. 7, in the case where breakage C such as a crack occurs in the fixing sleeve 20, the divided heat generating layer 20b-1 does not generate the Joule heat. In that case, the thermistor 2 not only cannot maintain and adjust the surface temperature of the fixing sleeve 20 to a predetermined target temperature but also cannot function as the above-described energization shut-off element.

On the other hand, the current monitoring sensor 1 as the conduction monitoring means sends a voltage signal to a detection result comparing portion 44, and the detection result comparing portion 44 discriminates that breakage occurs in the case where a predetermined voltage or less is detected and then sends a breakage detection signal to the engine controller 41. The engine controller 41 received the breakage detection signal prohibits the supply of the electric power and urgently stops the image forming operation.

Incidentally, as shown in FIG. 8, in the case where the breakage C occurs in the divided heat generating layer different from the divided heat generating layer corresponding to the thermistor 2, there is a possibility that a broken portion becomes a low temperature compared with other portions and causes an image defect. However, the surface temperature of the fixing sleeve 20 can be maintained and adjusted to the predetermined target temperature, and therefore, there is no need to prohibit the supply of the electric power to the fixing sleeve 20.

### Conduction Monitoring Means

A principle of the current monitoring sensor 1 as the conduction monitoring means will be specifically described. As described above, in this embodiment, a circumferential (circulating) current by the induced electromotive force flows in the heat generating pattern 20b. The induced electromotive force is proportional to the time change of magnetic flux φ generated by the exciting coil 22 as in the above-described formula. For that reason, the induced electromotive force V can be acquired by being measured by connecting a general-purpose current measuring circuit with the exciting coil 22 in series.

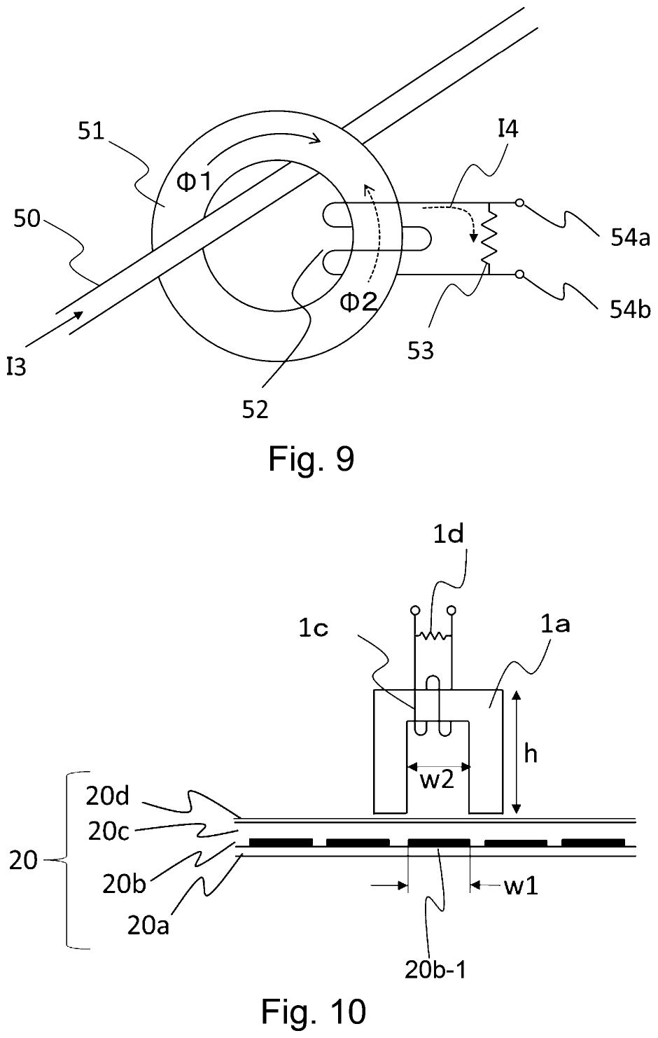

On the other hand, the circumferential current flowing in the heat generating pattern 20b cannot be measured by connecting the current measuring circuit in series. Therefore, a principle of current detection by a current transformer which is a type of a non-contact current sensor is applied. FIG. 9 is an illustration of the principle of the current detection by the current transformer. An alternating current I3 flowing in a measurement electroconductor 50 generates magnetic flux φ1 in a magnetic core 51. The generated magnetic flux φ1 induces a secondary current I4, depending on a winding number ratio, in a coil 52, and consequently generates magnetic flux φ2 in a direction of canceling the magnetic flux φ1.

The secondary current I4 generates a voltage between opposite terminals 54a and 54b of a shunt resistor 53. This voltage between the opposite terminals 54a and 54b is proportional to the alternating current I3 flowing in the measurement electroconductor 50, and therefore, on the basis of measurement of the voltage between the opposite terminals 54a and 54b, the current (the alternating current I3 flowing in the measurement electroconductor) can be acquired.

Thus, in this embodiment, the current monitoring sensor 1 as a second element is provided so as to cause a voltage change are a current change due to electromagnetic induction with breakage (disconnection) of the heat generating pattern.

Next, a specific structure of the current monitoring sensor 1 as the conduction monitoring means in this embodiment will be described in detail. FIG. 10 is a sectional view showing a structure of the current monitoring sensor. Outside the fixing sleeve 20, a U-shaped magnetic core 1a (second magnetic core) for monitoring electric conduction different from the magnetic core 21 (first magnetic core) for induction heating is provided.

Further, a detection coil 1c is wound around the magnetic core 1c, and a shunt resistor 1d is connected to opposite terminals of the detection coil 1c. This structure is the same in principle as the current transformer type currents sensor of FIG. 9 except that a magnetic path by the magnetic core is partially deficient compared with the current transformer type current sensor.

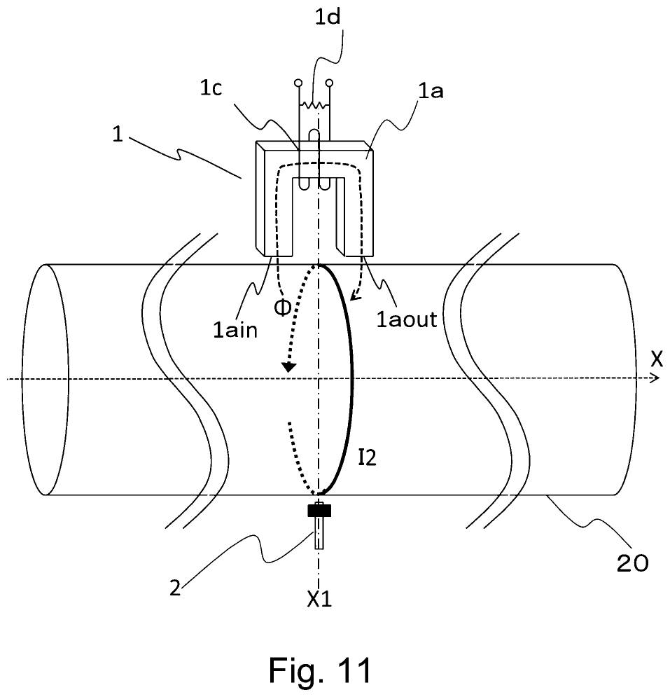

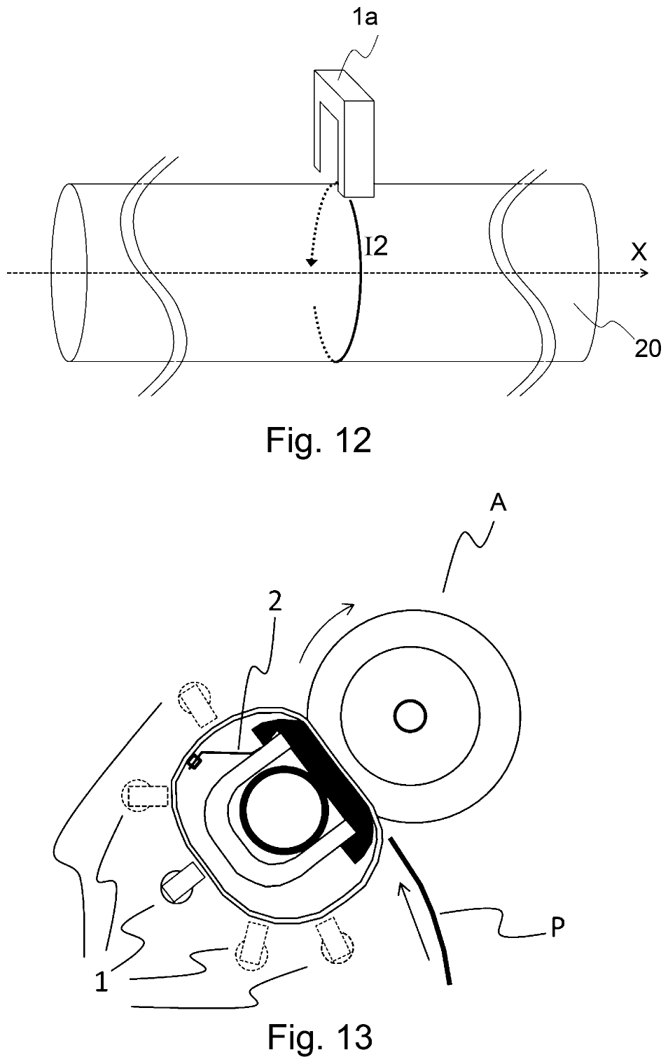

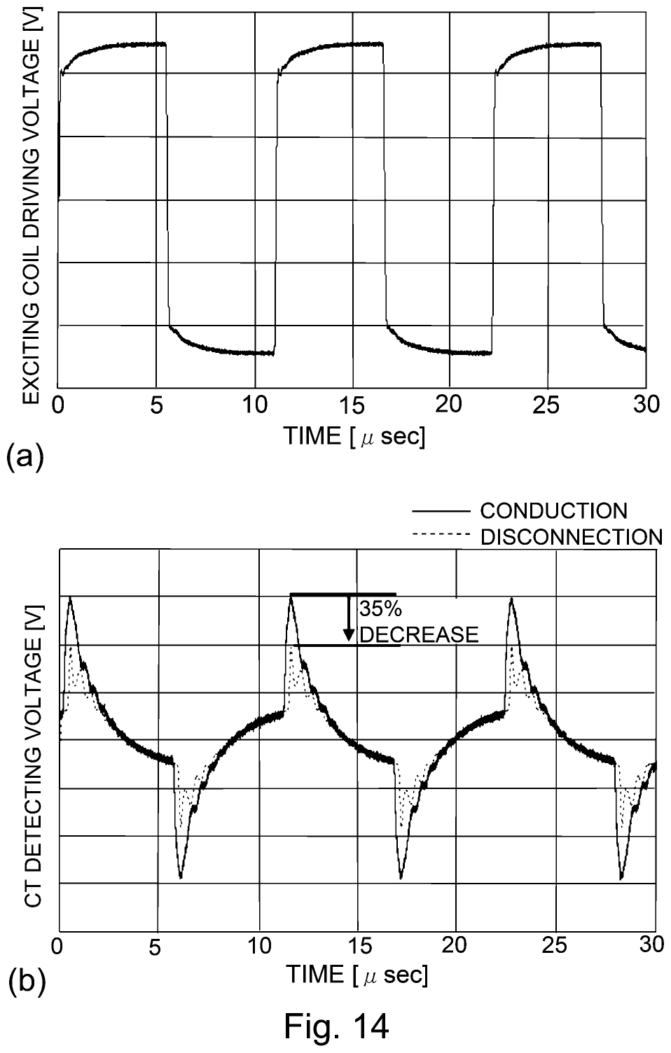

The detection coil 1c is disposed so that a helical axis thereof is substantially parallel to the helical axis (the X-axis direction of FIG. 11) of the exciting coil 22. The magnetic core 1a is disposed so that two leg portions constituting the U-shape are substantially parallel the helical axis of the exciting coil 22. With respect to the longitudinal direction of the fixing sleeve 20, a center position of the magnetic core 1a and a position of the thermistor 2 coincide with each other.

FIG. 11 is a perspective view representing that magnetic flux φ generates in a magnetic path formed by the magnetic core 1a is generated by a circumferential current 2 flowing in the fixing sleeve 20. By the principle of the above-described current transformer type current sensor, in the detection coil 1c, the alternating current depending on the winding number ratio of the detection coil 1c flows in the detection coil 1c so as to cancel the generated magnetic flux, so that a voltage generates at the opposite terminals of the shunt resistor 1d. This voltage is proportional to the circumferential current flowing in the fixing sleeve 20, and therefore, a current amount thereof can be discriminated.

A most important structural factor in the magnetic core 1a is a positional relationship between the circumferential current flowing in the fixing sleeve 20, and an inlet 1a in and an outlet 1a out of the magnetic flux of the magnetic core 1a. There is a need that the detection coil 1c is not wound around the inlet 1ain and the outlet 1aout and thus the inlet 1ain and the outlet 1aout are exposed magnetically. Further, the inlet 1ain and the outlet 1aout of the magnetic flux may desirably be in a positional relationship in which they oppose each other so that the current I2 to be monitored in interposed therebetween.

In FIG. 10, a width W1 of the divided heat generating layer 20b-1 and a width W2 between the two leg portions of the magnetic core 1a may preferably be the same as each other. In this embodiment, the width W1 of the divided heat generating layer 20b-1 is set at 3 mm, and the width W2 of the magnetic core 1a is set at 3 mm. The magnetic core 1a has a thickness (length with respect to a direction perpendicular to the drawing sheet of FIG. 10) of 2 mm and a height h of 5 mm.

Further, the detection coil 1c was 50 (times) in the number of winding and 1 kΩ in magnitude of the shunt resistor 1d. Incidentally, as shown in FIG. 12, when the magnetic core 1a is disposed in parallel to the circumferential direction of the fixing sleeve 20, the current little flows in the detection coil and thus does not perform the current detecting function.

The function of the current monitoring sensor 1 as the conduction monitoring means in this embodiment is to discriminate whether the divided heat generating layer 20b-1 is normal or broken at the position where the thermistor 2 detects the surface temperature of the fixing sleeve 20.

Accordingly, as shown in FIG. 11, when a center position of the thermistor 2 with respect to the longitudinal direction (X-axis direction) of the fixing sleeve 20 is X1, there is a need to establish a positional relationship in which the inlet 1ain and the outlet 1aout of the magnetic flux oppose each other so as to sandwich the center position X1 therebetween. Incidentally, as regards a direction perpendicular to the X-axis, i.e., the circumferential direction of the fixing sleeve 20, there is no particularly necessary condition, so that the current monitoring sensor 1 can be provided at any circumferential direction as indicated by broken lines of FIG. 13.

### Check Result

Part (a) of FIG. 14 shows a waveform of a driving voltage when a driving current of 90 kHz is caused to pass through the exciting coil 22 from the exciting circuit 43, the driving voltage is a rectangular voltage of about 11 μsec in cyclic period. An alternating magnetic field generating with this voltage causes the heat generating pattern of the fixing sleeve 20 to generate the induced electromotive force. Part (b) of FIG. 14 shows a voltage waveform applied to the opposite terminals of the shunt resistor 1d (FIG. 11) of the current monitoring sensor 1. A solid line represents the voltage waveform in the case where there is no breakage in the heat generating pattern of the fixing sleeve 20, and a broken line represents the voltage waveform in the case where breakage occurs in the heat generating pattern of the fixing sleeve 20.

The voltage exerted on the opposite terminals of the shunt resistor 1d is decreased by 35% in the case where disconnection occurs due to the breakage compared with the case where the heat generating pattern of the fixing sleeve 20 is connected with respect to the circumferential direction (in the case where there is no disconnection due to the breakage). The above-described analog voltage signal is sent to the detection result comparing portion 44. The detection result comparing portion 44 analyzes the sent analog voltage signal, and for example, program is made so that the disconnection due to the breakage is recognized when the voltage value is decreased by 25% or more than the voltage value during normal operation stored in an unshown memory.

As described above, the current monitoring sensor 1 detects the voltage exerted on the opposite terminals of the shunt resistor 1d, and a difference between the detected voltage value and a voltage value in the case where there is no disconnection due to the breakage is detected by the detection result comparing portion 44, whereby the detection result comparing portion 44 discriminates occurrence or non-occurrence of the breakage due to the heat generating pattern of the fixing sleeve 20. The detection result comparing portion 44 is capable of sending a breakage detection signal to the engine controller 41. As a result, the engine controller 41 is capable of stopping supply of the electric power to the fixing sleeve with reliability.

Incidentally, in this embodiment, the thermistor 2 as the energization shut-off element (first element) for shutting off the supply of the electric power when abnormal temperature rise is positioned was described, but it is possible to use a thermo-switch having a constitution in which the current is shut off by inversion of bimetal at a predetermined temperature. Or, it is also possible to use a thermal fuse or the like capable of shutting off the current by operation of a spring mechanism by melting a pellet.

### Second Embodiment

A difference of a second embodiment of the present invention from the first embodiment is that a magnetic core is added to an inside of the fixing sleeve 20, and has a constitution in which detection accuracy is further improved. In the following, a current monitoring sensor 1 as the conduction monitoring means will be specifically described.

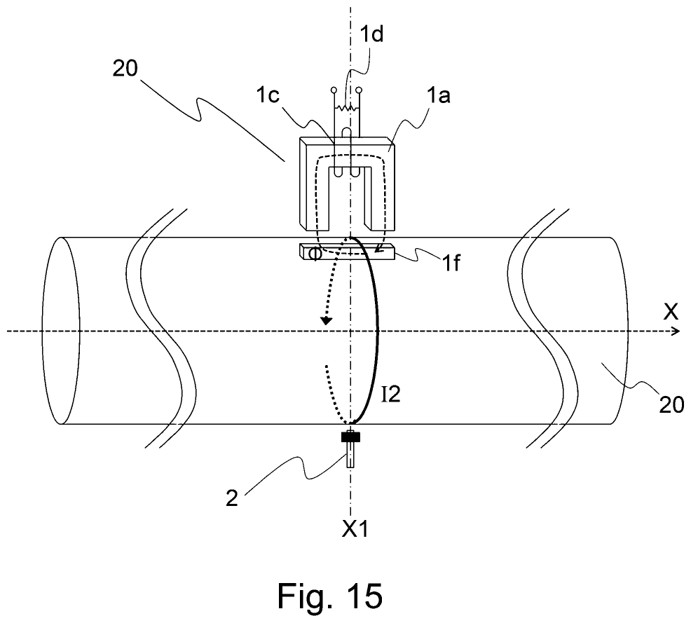

FIG. 15 is a perspective view showing a structure of the current monitoring sensor 1 in this embodiment. A magnetic core if is provided inside the fixing sleeve 20. Structures of other members such as the magnetic core 1a, the detection coil 1c and the shunt resistor 1d are the same as those in the first embodiment. When compared with the current transformer type current sensor, similarly as in the first embodiment, the constitution of this embodiment is such that the magnetic path is partially deficient. However, compared with the first embodiment, a degree of deficiency is small, so that the constitution closer to the magnetic path of the current transformer type current sensor is employed.

As a result, the current monitoring sensor 1 is capable of grasping the change of the magnetic flux φ due to the circumferential current I2 more reliably.

### Check Result

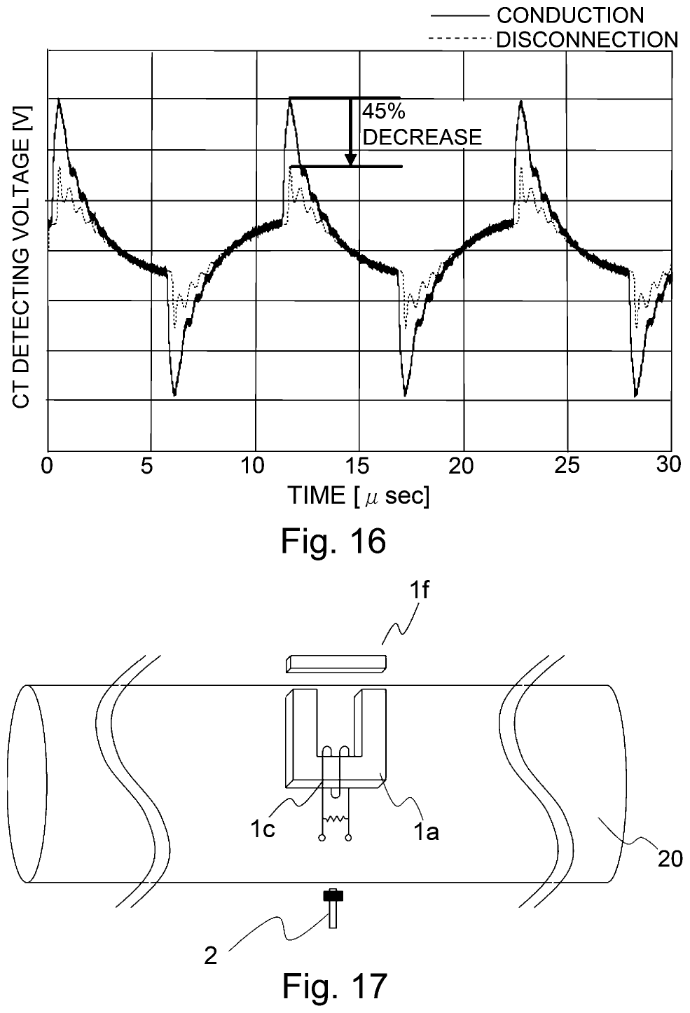

FIG. 16 shows a waveform of a voltage applied between opposite terminals of the shunt resistor 1d of the current monitoring sensor 1 in this embodiment. A solid line represents the voltage waveform in the case where there is no breakage in the heat generating pattern of the fixing sleeve 20, and a broken line represents the voltage waveform in the case where the breakage occurs in the heat generating pattern of the fixing sleeve 20. In the case where the breakage occurs, the current does not flow and a signal of the current monitoring sensor 1 becomes small, so that a voltage value decreases by 45%.

As described above, by adding the magnetic core to the inside of the fixing sleeve 20, a constitution in which the degree of the deficiency of the magnetic path by the magnetic core is small is provided, so that detection accuracy is improved and reliability is enhanced.

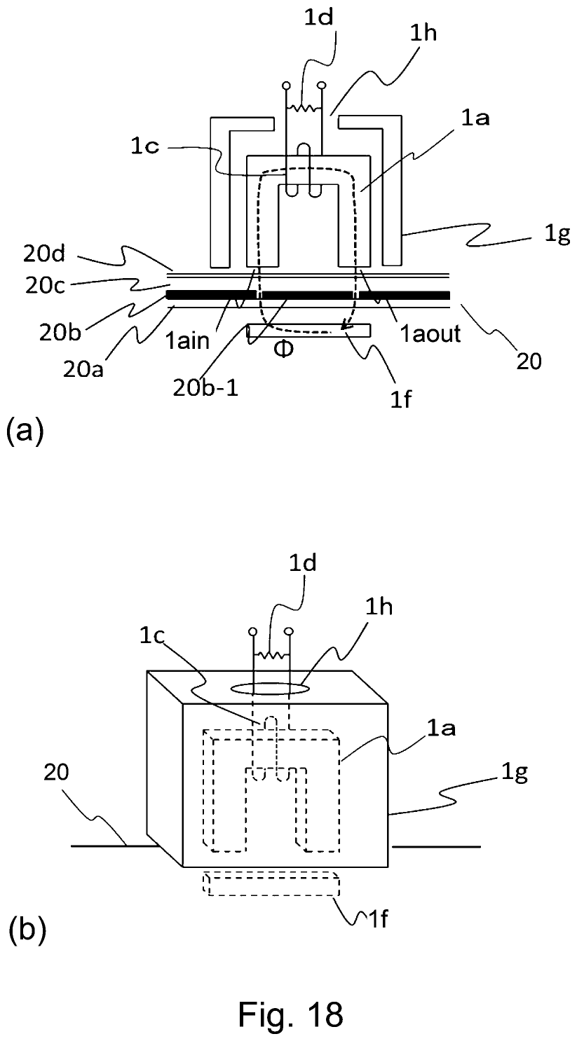

As described above, in this embodiment, the example in which similarly as in the first embodiment, as the current monitoring sensor 1, the principle of the current transformer type current sensor including the magnetic core was described. Incidentally, in principle, as shown in FIG. 17, the magnetic core 1a and the detection coil 1d, and the magnetic core 1f may also be replaced between the outside and the inside relative to the constitution of FIG. 15.

### Third Embodiment

A difference of this embodiment from the first embodiment and the second embodiment is that a magnetic shield 1g as a magnetic shield member surrounding the magnetic core 1a is added. A constitution of this embodiment is a constitution in which detection accuracy is further improved. In the following, a current monitoring sensor (device) 1 in this embodiment will be specifically described.

Parts (a) and (b) of FIG. 18 are a sectional view and a perspective view, respectively, showing a structure of a current monitoring device. The magnetic shield 1g is disposed so as to surround the magnetic core 1a and the detection coil 1c, and a side where the inlet 1ain and the outlet 1aout are provided is an opening, so that incidence of the magnetic flux φ is not prevented. Further, the magnetic shield 1g is provided with an opening 1h on an upper surface side of the figure, and wiring is guided from the detection coil 1c through the opening 1h. Structures of other members such as magnetic cores 1a and 1f, the detection coil 1c and the shunt resistor 1d are the same as those in the second embodiment.

A material of the magnetic shield 1g may desirably be constituted by low-resistance metal, such as aluminum or copper, as an electroconductive member and may preferably have a thickness of 1 mm or more. The magnetic shield 1g is capable of suppressing noise entering through a portion other than the inlet 1ain and the outlet 1aout of the magnetic flux of the current monitoring sensor (device) 1. Accordingly, the constitution of this embodiment is capable of more reliably grasping the change of the magnetic flux φ due to the circumferential current I2, so that a difference between the case where there is no breakage in the heat generating pattern of the fixing sleeve 20 and the case where the breakage occurs in the heat generating pattern of the fixing sleeve 20 becomes large.

### Check Result

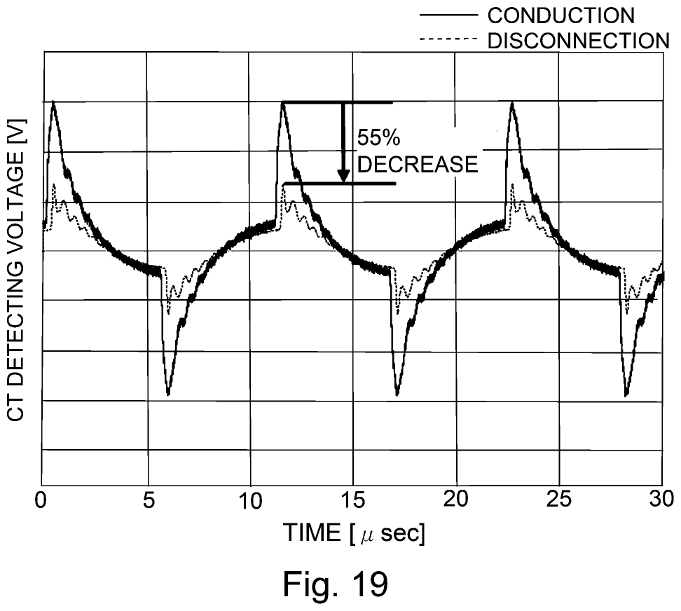

FIG. 19 shows a waveform of a voltage applied between opposite terminals of the shunt resistor 1d of the current monitoring sensor 1 in this embodiment. A solid line represents the voltage waveform in the case where there is no breakage in the heat generating pattern of the fixing sleeve 20, and a broken line represents the voltage waveform in the case where the breakage occurs in the heat generating pattern of the fixing sleeve 20 in the neighborhood of the current monitoring sensor (device) 1, In the case where the breakage occurs, the current does not flow and a signal of the current monitoring sensor (device) 1 becomes small, so that a voltage value decreases by 55%.

As described above, by employing the constitution the magnetic shield surrounding the magnetic core prevents the magnetic flux to enter the magnetic core 1c through a place other than the openings of the current monitoring sensor (device) 1, so that detection accuracy is further improved and reliability is enhanced. In this embodiment, by using an electroconductive member as the magnetic shield, electromagnetic wave is absorbed and multiple-reflected, whereby electromagnetic energy is attenuated. Incidentally, also in the case where the magnetic field is shielded by absorbing the magnetic flux with use of ferromagnetic material, a similar effect is achieved. In that case, a material of the magnetic shield 1g may desirably be a soft magnetic material such as ferrite, permalloy or silicon steel.

### Fourth Embodiment

This embodiment is different in breakage discriminating means from the first to third embodiments. Other constitution of main component parts of the fixing sleeve, the thermistor and the fixing device are similar to those in the above-described embodiments.

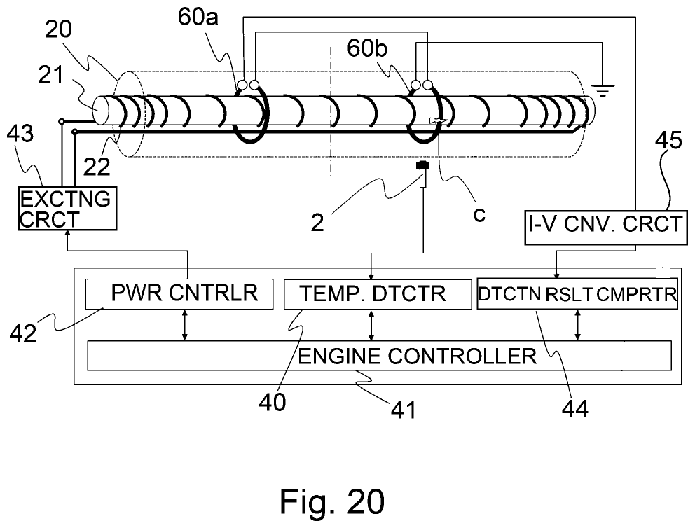

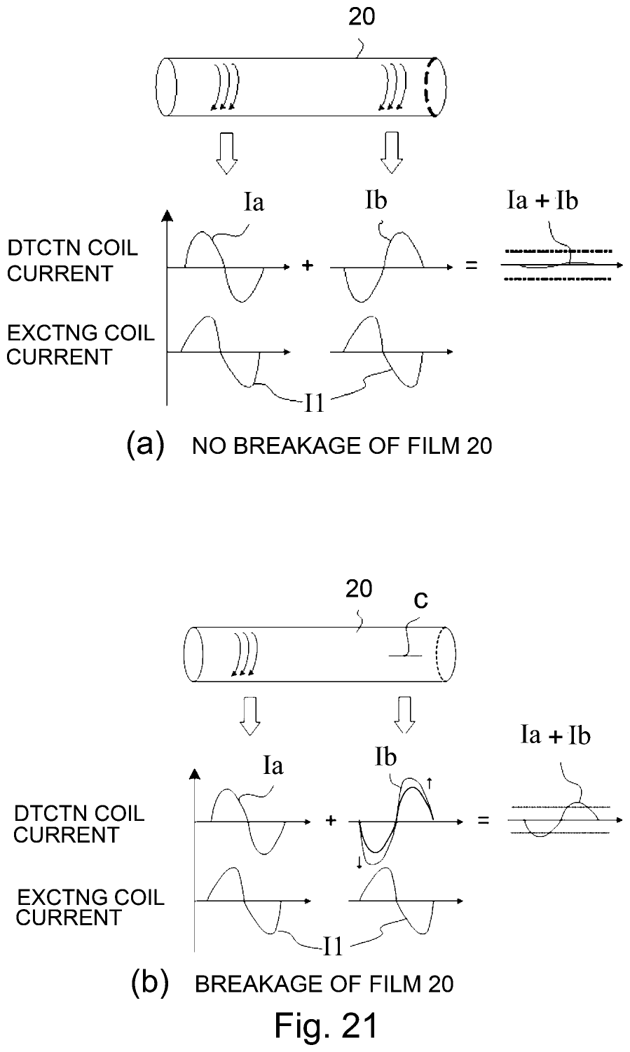

In the following, the breakage discriminating means in this embodiment will be specifically described with reference to FIG. 20. Around a magnetic core 21, each of induced current detection coils 60a and 60b is wound one time (one turn). A winding position of the detection coil 60b coincide with a position of the thermistor 2 with respect to the longitudinal direction of the fixing sleeve 20. A position of the detection coil 60a is a symmetrical position with the position of the detection coil 60b with respect to a longitudinal center position of the magnetic core 21.

One terminal of the detection coil 60b is connected to the ground, and the other terminal is connected so as to be in series with the detection coil 60a (hereinafter, this coil connected in series is represented by a detection coil 60a-b). Further, as a feature, the detection coil 60a-b is connected, with respect to the detection coils 60a and 60b, in series in directions in which generated voltages are canceled with each other. The other terminal of the detection coil 60a is connected to an I-V conversion circuit 45, and an output of the I-V conversion circuit 45 is inputted to the detection result comparing portion 44.

The detection result comparing portion 44 analyzes a signal which has been sent, and for example, in the case where the detection result comparing portion 44 discriminates that the sent signal is different from a voltage waveform during normal operation stored in an unshown memory, the detection result comparing portion 44 discriminates that the fixing sleeve 20 is broken. In that case, the detection result comparing portion 44 sends a breakage detection signal to the engine controller, and the engine controller stops the supply of the electric power to the fixing sleeve 20.

Part (a) of FIG. 21 shows a current waveform I1 during energization of a driving current to an exciting coil 22, an induced current waveform Ia flowing through the detection coil 60a, and an induced current waveform Ib flowing through the detection coil 60b, in the case where there is no breakage in the heat generating pattern of the fixing sleeve 20. Part (a) of FIG. 21 further shows an induced current waveform (Ia+Ib: combined (synthetic) waveform) flowing through the detection coil 60a-b. Part (b) of FIG. 21 shows respective current waveforms in the case where the breakage occurs in the heat generating pattern of the fixing sleeve 20 in the neighborhood of a winding position of the detection coil 60b which is the same position as the thermistor 2 with respect to the longitudinal direction of the fixing sleeve 20.

In part (a) of FIG. 21, when the driving current I1 flows through the exciting coil 22, the induced current Ia generates in the detection coil 60a. Similarly, in the detection coil 60b wound in an opposite direction to the detection coil 60a at a symmetrical position with the detection coil 60a, the induced current Ib which is the same in amplitude as the induced current Ia and which is reversed in the direction of the current generates. The detection coils 60a and 60b are connected in series, and therefore, the currents flowing through the detection coils 60a and 60b are canceled with each other, so that the combined current Ia+Ib becomes substantially 0.

On the other hand, in part (b) of FIG. 21, in the case where the breakage occurs in the heat generating pattern of the fixing sleeve 20 at a portion C, the induced current Ib generating in the detection coil 60b increases in amplitude. This is because a resistance value of the fixing sleeve 20 with respect to the circumferential direction substantially increases and therefore an amount of a circumferential current of the fixing sleeve 20 induced by the magnetic flux decreases, and correspondingly, a proportion thereto an amount of the current induced on the detection coil 60b side increases. As a result, the currents flowing as the induced currents Ia and Ib cannot be canceled with each other, so that the combined current Ia+Ib flows in an amplitude amount depending on a breakage amount.

The current is converted into a voltage by the I-V conversion circuit 45, and the voltage is discriminated by the detection result comparing portion 44 whether or not the voltage is a predetermined threshold or more. As described above, in this embodiment, the breakage can be detected utilizing an increase in proportion of the current amount induced in the detection coil 60b side correspondingly to a decrease in circumferential current amount of the fixing sleeve 20 on the detection coil 60b side where the detection coil 60b is wound around the magnetic core 21.

In this embodiment, the purpose of disposing the detection coils 60a and 60b in bilaterally symmetrical positions with respect to the longitudinal center position of the magnetic core 21 is easy detection of an increment of the induced current Ib. Therefore, in the case where there is no breakage in the heat generating pattern of the fixing sleeve 20 in part (a) of FIG. 21, it is preferable that the current waveforms of the induced currents Ia and Ib closely resemble each other. In the case where the breakage occurs in the heat generating pattern of the fixing sleeve 20 in part (b) of FIG. 21, when the change in induced current Ib can be largely ensured, it is not necessarily required that the detection coils 60b and 60a are disposed at the bilaterally symmetrical positions.

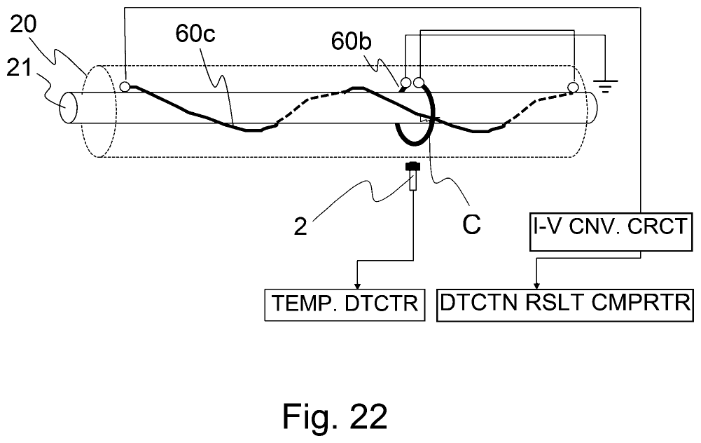

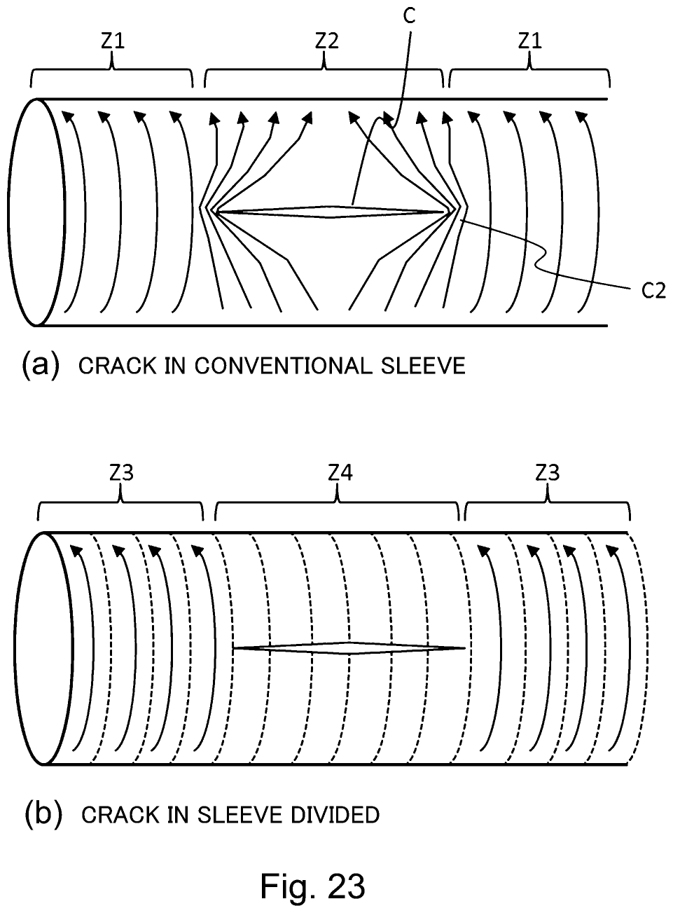

In that case, by changing the position of the detection coil 60a without changing the position of the detection coil 60b, as in the case of a detection coil 60c in FIG. 22, it is also possible to employ a constitution in which the detection coil 60c is wound around entirety of the magnetic core 21.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-183212 filed on Sep. 28, 2018, which is hereby incorporated by reference herein in its entirety.

What is claimed is:

1. An image heating apparatus comprising:
a sleeve which is rotatable while contacting a recording material on which an image is formed, said sleeve including a plurality of divided heat generating layers arranged along a longitudinal direction of said sleeve, wherein each of said divided heat generating layers has a ring shape;
an exciting coil provided in an inside space of said sleeve, wherein said exciting coil has a helix substantially parallel to the longitudinal direction of said sleeve;
a magnetic core provided inside said exciting coil; and
a temperature detecting element opposing one of said divided heat generating layers,
wherein an induced current is generated in said divided heat generating layers by passing an alternating current through said exciting coil, and said divided heat generating layers generate heat,
wherein the image on the recording material is heated by said divided heat generating layers, and
wherein said image heating apparatus further comprises a current monitoring sensor configured to monitor a current flowing through said one of said divided heat generating layers.

2. An image heating apparatus according to claim 1, wherein when said exciting coil provided in the inside space of said sleeve is a first exciting coil and said magnetic core is a first magnetic core, said current monitoring sensor includes a second exciting coil and second magnetic core penetrating through an inside of said second exciting coil, and
wherein said current monitoring sensor monitors the current flowing through said one of said divided heat generating layers by a voltage generating in said second exciting coil by the current flowing through said one of said divided heat generating layers.

3. An image heating apparatus according to claim 2, wherein said second exciting coil has a U shape provided with two legs, and
wherein said second exciting coil and said second magnetic core are provided so that the two legs are substantially parallel to the longitudinal direction of said sleeve.

4. An image heating apparatus according to claim 3, wherein said second exciting coil and said second magnetic core are disposed inside or outside said sleeve, and
wherein at a position opposing said second magnetic core through said sleeve, a third magnetic core configured to guide magnetic flux passing through said second magnetic core is provided.

5. An image heating apparatus according to claim 1, wherein said sleeve is a film.
